(19) United States
(12) Patent Application Publication
(10) Pub. No.: US 2003/0143331 A1
(43) Pub. Date: Jul. 31, 2003

(54) Attachment of thiophosphate tethered oligonucleotides to a solid surface

(75) Inventors: Radhakrishnan P. Iyer, Shrewsbury, MA (US); Rajendra K. Pandey, Farmington, MA (US); Satya N. Kuchimanchi, Acton, MA (US); Arlene Roland, Castries (FR)

Correspondence Address: SEED INTELLECTUAL PROPERTY LAW GROUP PLLC, 701 FIFTH AVE, SUITE 6300, SEATTLE, WA, 98104-7092, US

(73) Assignee: Micrologix Biotech Inc., Vancouver, BC (CA)

(21) Appl. No.: 10/264,313

(22) Filed: Oct. 3, 2002

Related U.S. Application Data
(60) Provisional application No. 60/326,872, filed on Oct. 3, 2001.

(51) Int. Cl. B05D 3/00

(52) U.S. Cl. 427/331

(57) ABSTRACT

The present invention provides an alternative method of attaching a 3′-thiophosphate mononucleotide or oligonucleotide to a solid support. The method permits chemoselective binding of a thiophosphate mono- or oligonucleotide to a solid support. The present invention is useful in production of microarrays, chips, beads or other solid matrices for gene expression profiling, single nucleotide polymorphism, and pharmacogenomics, target validation, sequencing and for any application that involves contacting a target nucleic acid sequence with a support-bound probe.

### CROSS-REFERENCE TO RELATED APPLICATION

This application claims the benefit of U.S. Provisional Patent Application No. 60/326,872 filed Oct. 3, 2001, where this provisional application is incorporated herein by reference in its entirety.

### BACKGROUND OF THE INVENTION

1. Field of the Invention

The present invention relates to the field of solid phase oligonucleotide synthesis and attachment, and more specifically, to chemoselective binding of thiophosphate mono- or oligonucleotide to a solid support.

2. Description of the Related Art

The use of oligonucleotides for such purposes as antisense inhibition of protein expression and as PCR primers is now well established. Particularly in the antisense field, modifications to an oligonucleotide have been deemed essential to improve oligonucleotide uptake, increase nuclease resistance of the oligonucleotide, and improve efficacy of protein expression. Modification of oligonucleotide backbones (e.g., phosphorothioate modification of internucleoside linkages) has been one area of study. Accordingly, there is a continuing need for alternative and improved methods of synthesis of modified oligonucleotides to achieve increased yields and purity while at the same time reducing synthesis time and costs.

### BRIEF SUMMARY OF THE INVENTION

The present invention provides an alternative method of attaching a thiophosphate mononucleotide or oligonucleotide to a solid support. The method comprises contacting a thiophosphate mono- or oligonucleotide with a functionalized solid support under conditions that facilitate attachment of the oligonucleotide to the functionalized solid support via the sulfur atom of the thiophosphate moiety of the oligonucleotide. In certain aspects, the method of the present inventions advantageously permits chemoselective binding of the thiophosphate mono- or oligonucleotide to the solid support.

The present invention is useful in microarrays, chips, beads or other solid matrices for gene expression profiling, single nucleotide polymorphism, and pharmacogenomics, target validation, sequencing and for any application that involves contacting a target nucleic acid sequence with a support-bound probe.

### BRIEF DESCRIPTION OF THE SEVERAL VIEWS OF THE DRAWING(S)

FIG. 1 schematically depicts two methods of functionalizing a solid support with an iodoalkyl moiety.

FIG. 2 schematically depicts synthesis of a 3′-thiophosphate dinucleotide.

FIG. 3 schematically depicts a method of attaching a 3′ thiophosphate dinucleotide to a silanized solid support.

FIG. 4 schematically depicts the silanization of a glass slide.

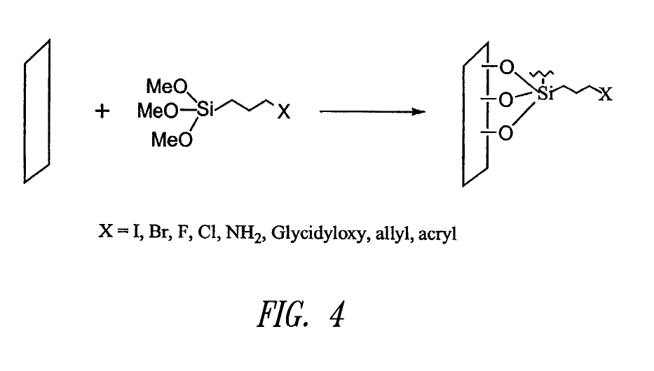

### DETAILED DESCRIPTION OF THE INVENTION

In one aspect, the present invention provides a method of attaching a thiophosphate mono- or oligonucleotide to a solid support. The method comprises contacting a thiophosphate mono- or oligonucleotide with a functionalized solid support under conditions that permit linkage of the sulfur of the 3′-thiophosphate to the solid support. In the method of the invention, the solid support is functionalized to have a linker moiety bearing a functional group (e.g., halo, amino, thiol, epoxy, or acryl). The thiophosphate mono- or oligonucleotide attaches to the solid support by covalent or ionic linkage to the functional group or displacement of the functional group.

In a preferred embodiment, the solid support is derivatized with an iodoalkyl moiety. In this embodiment, a thiophosphate mono- or oligonucleotide displaces the iodo moiety to covalently bond to the alkyl moiety attached to the solid support.

In another aspect, the invention provides an improved method of attaching a mono- or oligonucleotide to a solid support. In a preferred embodiment, the method comprises (a) functionalizing a solid support with a linker moiety bearing a functional group (e.g., halo, amino, thiol, epoxy, or acryl moieties); (b) functionalizing the mono- or oligonucleotide with a thiophosphate moiety; and c) contacting the thiophosphate mono- or oligonucleotide with the functionalized solid support under conditions that permit linkage of the support-bound linker to the sulfur of the thiophosphate. Preferably the thiophosphate mono- or oligonucleotide is a 3′- or 5′-thiophosphate mono- or oligonucleotide, and most preferably a 3′-thiophosphate mono- or oligonucleotide.

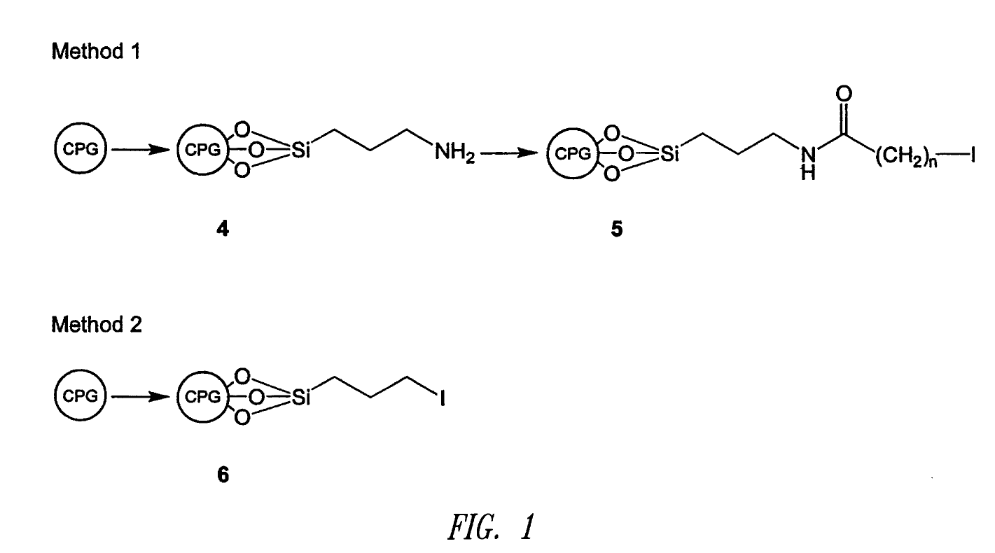

FIG. 1 displays two illustrative methods by which a solid support can be modified in accordance with the invention. While this figure displays a controlled pore glass (CPG) support, other art recognized solid supports can be used as well. Examples include polymer supports, 96 well plates, beads and membranes. In method 1, synthesis of the aminoalkyl functionalized support (4) can be accomplished using art recognized techniques (e.g., S. Agrawal, Ed., Methods in Molecular Biology, Vol. 20, “Protocols for Oligonucleotides and Analogs: Synthesis and Properties,” Chapter 19, Humana Press Inc., Totowa, N.J., 1993). Conversion of the aminoalkyl functional group to the iodoalkylcarboxamide (5) is accomplished by treating amino alkyl CPG or other supports with iodoalkyl carboxylic acids in presence of activating agents, carbonyl diimidazole (CDI), dicyclohexyl carbodiimide (DCC) or ethyl dimethylaminopropyl carbodiimide (EDC).

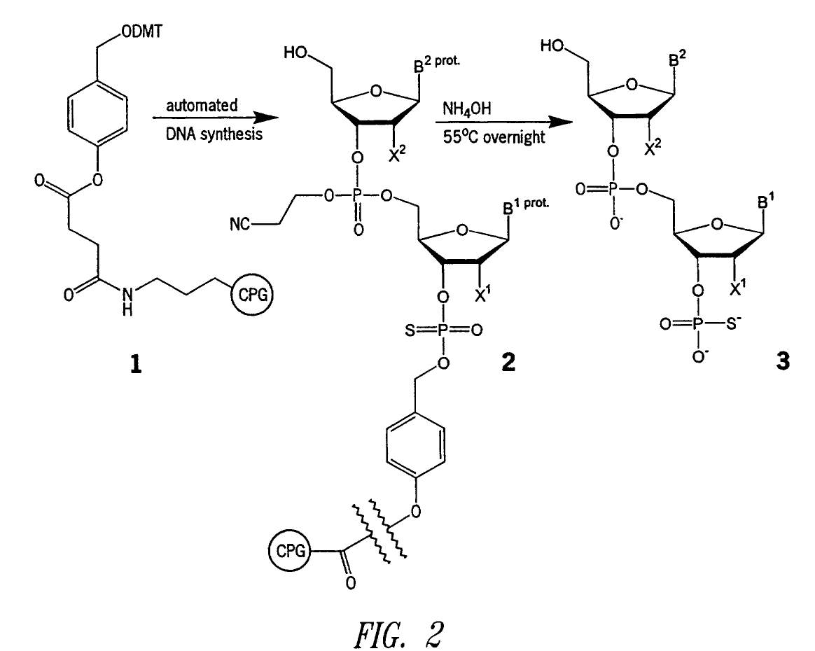

In FIG. 2, B¹ and B² are independently a naturally occurring base (adenine, thymine, cytidine or guanine), a non-naturally occurring base (with or without exocyclic modifications), or a heterocycles, and X¹ and X² are independently H, halo (F, Cl, Br, I), —NHR, —CO₂R, —SR or —OR, wherein R is C₁-C₆ alkyl, C₂-C₆ alkenyl, C₂-C₆ alkynyl, C₅-C₇ cycloalkyl, aryl, or C₁-C₆ alkyl and heterocycle. For the purposes of this invention, a heterocycle is a mono-, bi-, or tri-cyclic fused ring system comprised of C₅ or C₆ aromatic or non-aromatic rings, wherein from one to all rings have one, two, or three heteroatoms selected from O, N, and S, provided if two heteroatoms are adjacent in the ring, they are both N.

In the second method, the solid support is treated with trialkoxy-iodoalkyl silanes. In one preferred embodiment, the solid support is treated with trimethoxy iodopropyl silane.

Both 3′-and 5′-thiophosphate mono and oligonucleotides can be prepared by art-recognized techniques. FIG. 2 displays an exemplary synthesis of a 3′-thiophosphate dinucleotide.

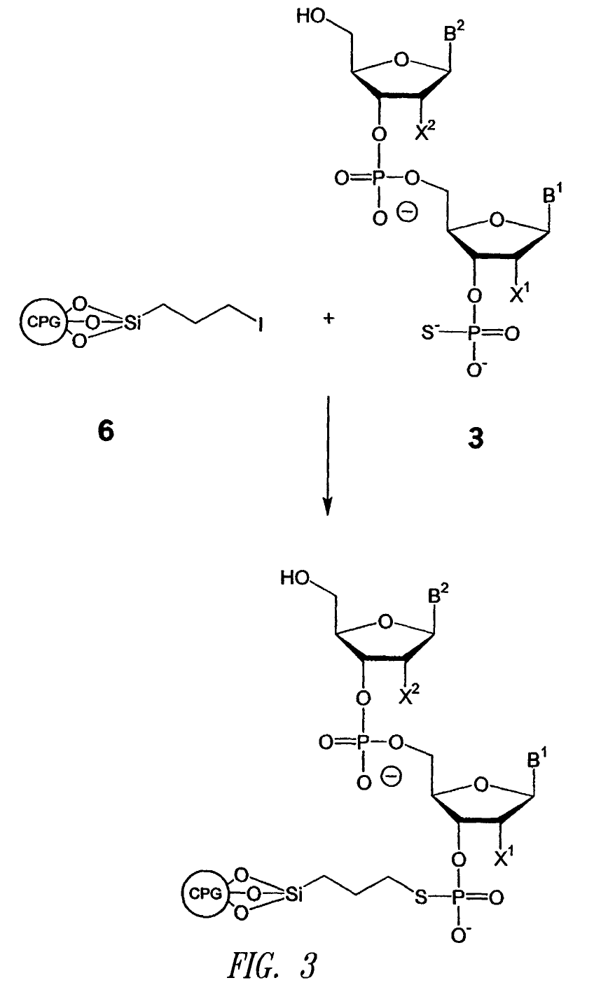

Either or both a 3′- and 5′-thiosphosphate mono- or oligonucleotides can then contacted with the iodoalkyl-functionalized solid support (e.g., 5 or 6 in FIG. 1) under conditions that permit displacement of the iodo moiety and binding of the thiophosphate mono- or oligonucleotide through the sulfur of the thiophosphate moiety. The attachment of a 3′-thiophosphate dinucleotide is depicted in FIG. 3.

For example, glass slides were silanized and had oligonucleotides attached as follows. Commercially available glass slides were placed in a slide holder and washed with water. The slides were then kept in 1 N sodium hydroxide bath overnight. At the end of this period, the slides were taken out and thoroughly washed with water, distilled water, and, finally, ethanol. The slides were then baked in a hot air oven at 110° C. for 2 h. The slides were allowed to come to room temperature. A 5% solution of trimethoxy isopropyl iodo silane was prepared in methanol. The slide chamber was filled with this solution (200 mL) and the slide rack containing the clean slides was placed in this container for a period of 2 h. The slide rack was taken out and the slides were washed thoroughly with ethanol. The silanized slides were dried in a hot air oven for 2 h at 110° C. Silanized slides were stored in a box under dust free conditions.

Oligonucleotides having a 3′-thiophosphate were prepared according to the procedure described in Roland et al. (Tetrahedron Letters 42:3669-72, 2001). Briefly, a 1 micromolar solution of the oligo was prepared in an appropriate buffer (100 mM phosphate, 25 mM tris or milliQ water). Spots of 1 microliter volume were placed on predetermined locations on the surface of the glass slide. The slides were allowed to air dry for 2 h and then were put in a hot air oven for an hour at 80° C. The slides were taken out from the oven and were allowed to come to room temperature. After a mild wash with water, the slides were shown to have the probes firmly attached to the surface.

In certain aspects (e.g., when using a haloalkyl derivatized support), the method of the invention is advantageous in that it permits chemoselective binding via the 3′- or 5′-terminal thiophosphate sulfur. By contrast, attachment of 3′- or 5′-thiophosphate to aminoalkyl-functionalized supports is nonchemoselective; they react with the internucleotide phosphodiesters to form phosphoramidates or bind with the amine surface to form an ionic complex as an acid-base reaction.

As used herein, an oligonucleotide is a polynucleotide chain of two or more nucleotides. In certain embodiments, oligonucleotides of the present invention will preferably have a length ranging from about 2 to about 1000 nucleotides, more preferably from about 2 to about 100 nucleotides, even more preferably from about 2 to about 50 nucleotides, and most preferably from about 2 to about 20 nucleotides. Any concentration or size ranges recited herein are to be understood to include concentrations of any integer within the range and fractions thereof, such as one tenth and one hundredth of an integer, unless otherwise indicated. Also as used herein, the term “about” means ±10% of the indicated value.

As described herein, the invention also comprises tethering of a 5′-thiophosphate mono- or oligonucleotide to a solid support by contacting a 5′-thiophosphate mono- or oligonucleotide with a solid support derivatized with a linker moiety bearing a leaving group (e.g., halo, amino, thiol, epoxy, or acryl) under conditions that permit displacement of the leaving group and covalent linkage of the sulfur of the 5′-thiophosphate to the solid support via the linker moiety in a preferred embodiment, the solid support is derivatized with an iodoalkyl moiety (i.e., the alkyl moiety is the linker and the iodo moiety is the leaving group).

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method of attaching a thiosphosphate mono- or oligonucleotide to a solid support, comprising contacting a thiosphosphate mono- or oligonucleotide with a solid support functionalized with a linker moiety bearing a functional group under conditions that permit linkage of the mono- or oligonucleotide to the solid support via the thiophosphate sulfur atom.

2. The method according to claim 1 wherein the functional group is selected from the group consisting of halo, amino, thiol, epoxy, and acryl.

3. The method according to claim 1 wherein the thiosphosphate mono- or oligonucleotide is a 3′-thiosphosphate mono- or oligonucleotide.

4. The method according to claim 1 wherein the thiosphosphate mono- or oligonucleotide is a 5′-thiosphosphate mono- or oligonucleotide.

5. The method according to claim 3 wherein the 3′-thiosphosphate mono- or oligonucleotide is a dinucleotide.

6. The method according to any one of claims 1-5 wherein the functional group is iodo and the link is alkyl.
